(19) United States
(12) Patent Application Publication
(10) Pub. No.: US 2023/0188011 A1
(43) Pub. Date: Jun. 15, 2023

(54) TELEMETRY SYSTEM FOR ELECTRIC MOTOR ROTOR

(71) Applicant: SCHAEFFLER TECHNOLOGIES AG & CO. KG, Herzogenaurach (DE)

(72) Inventor: Jacob SHERADIN, North Canton, OH (US)

(73) Assignee: SCHAEFFLER TECHNOLOGIES AG & CO. KG, Herzogenaurach (DE)

(21) Appl. No.: 17/551,017

(22) Filed: Dec. 14, 2021

(51) Int. Cl. H02K 11/25

(52) U.S. Cl. CPC H02K 11/25

(57) ABSTRACT

A system and methods are provided for a telemetry system for monitoring magnet temperatures within an operating electric motor. The telemetry system includes one or more sensors that are coupled with magnets comprising a rotor of the electric motor. A telemetry controller is mounted near a motor shaft comprising the rotor and wired to the sensors. The telemetry controller receives measured data signals from the sensors and transmits temperature-related information during operation of the electric motor. The telemetry controller is powered by way of an electric current induced in a winding coupled with a portion of the rotor that exposes the winding to a varying magnetic flux. The winding may comprise two or more smaller windings disposed at different locations of the rotor. A telemetry receiver is disposed in a stationary configuration nearby the electric motor such that wirelessly transmitted temperature-related information is received from the telemetry controller during operation of the electric motor.

### FIELD

Embodiments of the present disclosure generally relate to telemetry systems. More specifically, embodiments of the disclosure relate to a system and methods for a telemetry system for an electric motor rotor that provides an accurate measure of magnet temperature within an electric motor.

### BACKGROUND

Heat is known to impact the efficiency of an electric motor. The effects of excessive heat in magnets of the motor can degrade the performance of the motor if not dealt with properly. For example, heat produced during operation of the electric motor can distort the magnetic field of the motor, thereby impairing the output of the motor. Particularly in the case of induction motors, most of the heat is produced in the rotor due to electric current passing therethrough to generate torque. Heat can therefore impact the torque output capacity of electric motors. Accordingly, there is a continuous desire to develop an accurate understanding of the heat processes within electric motors.

Embodiments disclosed herein provide a telemetry system for an electric motor rotor that scavenges a small amount of operating magnetic flux to induce enough power to operate a telemetry controller and one or more temperature sensors coupled with magnets comprising the electric motor rotor.

### SUMMARY

A system and methods are provided for a telemetry system for monitoring magnet temperatures within an operating electric motor. The telemetry system includes one or more sensors that are coupled with magnets comprising a rotor of the electric motor. A telemetry controller is mounted near a motor shaft comprising the rotor and wired to the sensors. The telemetry controller is configured to receive measured data signals from the sensors and transmit temperature-related information during operation of the electric motor. The telemetry controller is powered by way of an electric current induced in a winding coupled with a portion of the rotor that exposes the winding to a varying magnetic flux. The winding may comprise two or more smaller windings disposed at different locations of the rotor. A telemetry receiver is disposed in a stationary configuration nearby the electric motor such that wirelessly transmitted temperature-related information is received from the telemetry controller during operation of the electric motor.

In an exemplary embodiment, a telemetry system for being coupled with a rotor of an electric motor comprises: one or more sensors for measuring properties of the rotor; a telemetry controller for receiving signals from the one or more sensors; a winding for powering the telemetry controller; and a telemetry receiver for wirelessly receiving measurement data from the telemetry controller.

In another exemplary embodiment, the telemetry controller is disposed on the rotor near a motor shaft comprising the electric motor. In another exemplary embodiment, the telemetry controller includes at least one processor and is configured to transmit wireless signals while rotating with the rotor during operation of the electric motor. In another exemplary embodiment, wires are arranged to place the telemetry controller into electrical communication with the one or more sensors.

In another exemplary embodiment, any one or more of the one or more sensors are configured to measure temperature. In another exemplary embodiment, any one or more of the one or more sensors are coupled with magnets comprising the rotor. In another exemplary embodiment, any one or more of the one or more sensors are coupled with suitable portions of ferrous material comprising the rotor.

In another exemplary embodiment, the winding is disposed on a portion of the rotor that causes a varying magnetic flux to pass through the winding during operation of the electric motor. In another exemplary embodiment, the winding is configured to pass an electric current induced by the varying magnetic flux to the telemetry controller. In another exemplary embodiment, the winding is disposed on at least one magnet comprising the rotor. In another exemplary embodiment, the winding is disposed on a suitable portion of ferrous material comprising the rotor.

In another exemplary embodiment, the winding comprises two or more smaller windings disposed at different locations of the rotor. In another exemplary embodiment, the two or more smaller windings having different shapes and sizes.

In another exemplary embodiment, the telemetry receiver is configured for wirelessly receiving temperature-related information pertaining to magnets comprising the rotor. In another exemplary embodiment, the telemetry receiver is configured to be disposed in a stationary disposition nearby the electric motor such that transmitted wireless signals may be received from the telemetry controller during operation of the electric motor. In another exemplary embodiment, the telemetry receiver comprises any of a computer, a tablet, a mobile phone, a personal digital assistant, a personal communicator, or other similar device.

In an exemplary embodiment, a method for monitoring magnet temperatures within an operating electric motor comprises: measuring the magnet temperatures by way of one or more sensors; receiving signals from the one or more sensors to a telemetry controller; transmitting magnet temperature information by way of the telemetry controller; establishing a wireless communication between the telemetry controller and a telemetry receiver; receiving the magnet temperature information to the telemetry receiver; and interpreting the magnet temperature information.

In another exemplary embodiment, the method further includes powering the telemetry controller by way of an electric current induced in a winding during operation of the electric motor.

In an exemplary embodiment, a method for a telemetry system for monitoring magnet temperatures within an operating electric motor comprises: coupling one or more sensors with magnets comprising a rotor of the electric motor; mounting a telemetry controller near a motor shaft comprising the rotor; arranging wires to place the telemetry controller into electrical communication with the one or more sensors; disposing a winding on a portion of the rotor that induces an electric current in the winding; powering the telemetry controller by way of the electric current; configuring the telemetry controller to transmit temperature-related information pertaining to the magnets; and configuring a telemetry receiver for wirelessly receiving the temperature-related information.

In another exemplary embodiment, disposing the winding includes coupling the winding with a portion of the rotor that causes a varying magnetic flux to pass through the winding during operation of the electric motor.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an isometric view of an exemplary embodiment of an electric motor rotor telemetry system coupled with a rotor and configured for providing an accurate measure of magnet temperatures within an electric motor, according to the present disclosure;

FIG. 2 is a block diagram illustrating an exemplary embodiment of an electric motor rotor telemetry system that includes a telemetry receiver for receiving temperature-related information pertaining to magnets within an electric motor in accordance with the present disclosure;

FIG. 3 is a flow chart illustrating an exemplary embodiment of a method for an electric motor rotor telemetry system to monitor magnet temperatures within an operating electric motor in accordance with the present disclosure; and

FIG. 4 is a flow chart illustrating an exemplary embodiment of a method for monitoring magnet temperatures within an operating electric motor, according to the present disclosure; and

FIG. 5 is a block diagram illustrating an exemplary data processing system that may be used in conjunction with an electric motor rotor telemetry system according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first magnet,” may be made. However, the specific numeric reference should not be interpreted as a literal sequential order but rather interpreted that the “first magnet” is different than a “second magnet.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Heat is known to impact the efficiency of an electric motor. The effects of excessive heat in magnets of the motor can degrade the performance of electric motors if not dealt with properly. Embodiments provided herein disclose a telemetry system for an electric motor rotor that scavenges a small amount of operating magnetic flux to induce enough power to operate a telemetry controller and one or more temperature sensors coupled with magnets comprising the electric motor rotor.

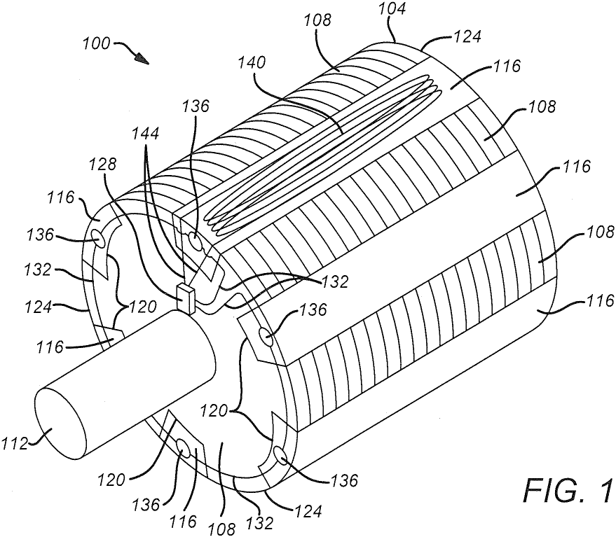

FIG. 1 illustrates an isometric view of an exemplary embodiment of an electric motor rotor telemetry system 100 coupled with a rotor 104 and configured to provide an accurate measure of magnet temperatures within an electric motor, according to the present disclosure. The rotor 104 generally is configured to be set into rotation within a stator comprising the electric motor. The stator is not shown herein for the sake of simplicity. The electric motor may be a permanent magnet variety of motor, or the electric motor may be any of variously configured induction motors, without limitation.

As shown in FIG. 1, the rotor 104 comprises a generally cylindrical portion of ferrous material 108 that is connected to a motor shaft 112. The ferrous material 108 may comprise any material capable of concentrating magnetic flux, such as iron and the like. The rotor 104 is non-rotatably connected to the motor shaft 112 such that the rotor 104 rotates with the motor shaft 112 during operation of the electric motor. In the illustrated embodiment, magnets 116 are retained within recesses 120 disposed around a periphery 124 of the rotor 104 and oriented parallel with the motor shaft 112. The illustrated embodiment of the magnets 116 may comprise permanent magnets. It should be borne in mind, however, that the system 100 is not limited to being coupled with permanent magnets, but rather the system 100 may be coupled with any device capable of producing a magnetic flux, such as motor windings, for the purpose of rotating the motor shaft 112, without limitation. Further, the system 100 is not limited to be practiced with inset rotor magnets 116, as shown in FIG. 1, but rather the system 100 may be practiced with any of various magnet configurations, such as surface mounted magnets, buried tangential magnets, buried radial magnets, buried V-magnets, buried multilayer V-magnets, and the like, without limitation.

With continuing reference to FIG. 1, the system 100 includes a telemetry controller 128 that is mounted or embedded on rotor 104 near the motor shaft 112. Wires 132 may be arranged to place the telemetry controller 128 into electrical communication with one or more sensors 136. In the illustrated embodiment, each of the sensors 136 is configured to measure temperature and thus each sensor 136 may be coupled with a magnet 116. In some embodiments, however, the sensors 136 may be configured to measure properties other than, or in addition to, magnet temperatures, and thus the sensors 136 may be coupled with any of various portions comprising the rotor 104, without limitation. For example, any one or more of the sensors 136 may be configured as thermo sensors and disposed within the electric motor to detect any of bearing temperatures, ambient temperatures within the motor, rotor airgap temperatures, winding temperatures, cooling air temperatures, inlet air temperatures, outlet air temperatures, and the like. Further, in some embodiments, any one or more of the sensors 136 may be configured to detect winding hot spots, such as, for example, hot spots that may arise within stator windings of the electric motor. Furthermore, any one or more of the sensors 136 may be implemented as mechanical sensors that are configured to detect machine vibrations that may arise during rotation of the rotor 104, as well as rotor position sensors, gyroscopic sensors, accelerometers, and the like. It is contemplated that deploying the sensors 136 as thermo and/or mechanical sensors enables intelligently controlling the operating temperatures of the electric motor and thus facilitates optimizing the cooling efficiency of the electric motor.

As will be appreciated, the wires 132 are configured to convey sensor data in the form of signals from the sensors 136 to the telemetry controller 128. In the illustrated embodiment of FIG. 1, the wires 132 are arranged around the periphery 124 of the rotor 104, forming a series circuit that connects the sensors 136 to the telemetry controller 128. It is contemplated, however, that a parallel circuit may be used to connect each sensor 136 to the telemetry controller 128 independently of the other sensors 136.

As further shown in FIG. 1, the system 100 includes an inductive winding 140 that is embedded or coupled with at least one of the magnets 116 and electrically connected to the telemetry controller 128 by way of wires 144. The winding 140 comprises a coil of wire that is configured to pass an electric current induced by varying magnetic flux to the telemetry controller 128 by way of the wires 144 during operation of the electric motor. It is contemplated that the electric current induced may be a relatively small current that is suitable for powering the telemetry controller 128 and the sensors 136 without adversely affecting operation of the electric motor. It is further contemplated that the winding 140 need not be disposed directly on the magnet 116, as shown in FIG. 1, but rather the winding 140 may be embedded or coupled with any suitable portion of the ferrous material 108, without limitation. Moreover, the system 100 is not to be limited to including one winding 140. In some embodiments, therefore, the system 100 may include more than one winding 140, without limitation.

Moreover, it should be understood that the winding 140 shown in FIG. 1 is purely illustrative in nature. In practice, therefore, the winding 140 need not be limited to the size and shape of the winding shown in FIG. 1. For example, in some embodiments, the winding 140 may be implemented as one or more small, circular windings that are adhered to exterior portions of the ferrous material 108 between adjacent magnets 116. Thus, it is contemplated that the windings 140 may be disposed in any location that doesn’t adversely affect the operation of the electric motor.

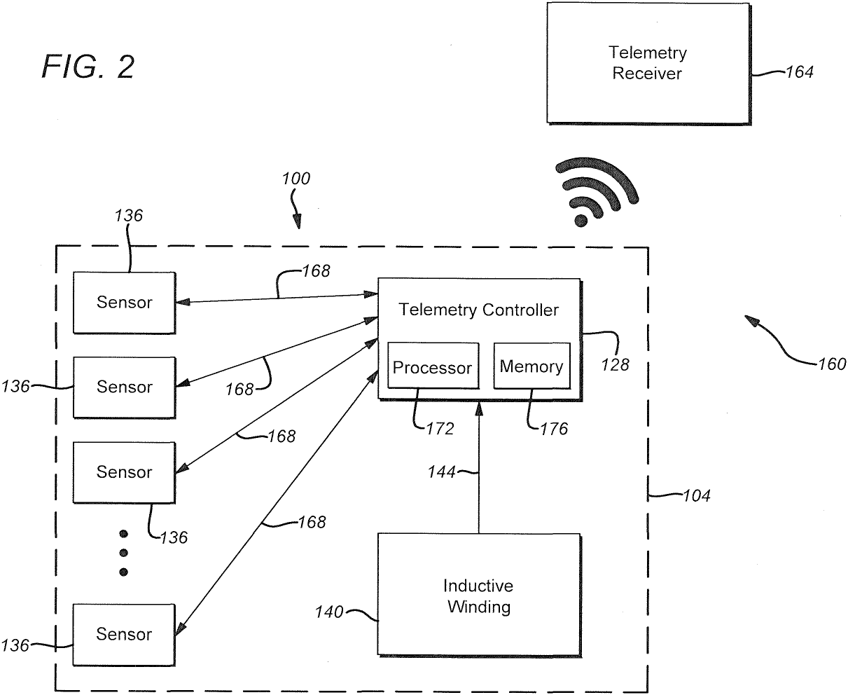

FIG. 2 is a block diagram illustrating an exemplary embodiment of an electric motor rotor telemetry system 160 that includes a telemetry receiver 164 for wirelessly receiving temperature-related information pertaining to magnets 116 within an electric motor in accordance with the present disclosure. The electric motor rotor telemetry system 160 may include the above-described system 100 coupled with the rotor 104 of the electric motor. As such, the system 100 includes a telemetry controller 128 that is mounted or embedded near a motor shaft 112 comprising the electric motor. Wires 168 place the telemetry controller 128 into electrical communication with multiple sensors, such as the sensors 136, that are coupled with magnets 116 within the electric motor and configured to measure temperature of the magnets 116. As will be appreciated, the wires 168 are configured to convey temperature-related signals from the sensors 136 to the telemetry controller 128. In the embodiment shown in FIG. 2, the wires 168 comprise a parallel circuit wherein each of the wires 168 connects one sensor 136 to the telemetry controller 128 independently of the other sensors 136. In some embodiments, however, the sensors 136 may be connected in series to form a series circuit that connects the sensors 136 to the telemetry controller 128, as shown in FIG. 1.

It should be borne in mind that the sensors 136 are not to be limited to measuring magnet temperatures. For example, in some embodiments, the sensors 136 may be configured to measure properties other than, or in addition to, magnet temperatures, and thus the sensors 136 may be coupled with any of various portions comprising the electric motor, without limitation. For instance, in one exemplary embodiment any one or more of the sensors 136 may be configured in the form of thermo sensors and disposed within the electric motor to detect any of bearing temperatures, ambient temperatures within the motor, rotor airgap temperatures, winding temperatures, cooling air temperatures, inlet air temperatures, outlet air temperatures, and the like. Further, in some embodiments, any one or more of the sensors 136 may be configured to detect winding hot spots, such as, for example, hot spots that may arise within stator windings of the electric motor. Furthermore, any one or more of the sensors 136 may be implemented as mechanical sensors that are configured to detect machine vibrations that may arise during rotation of the rotor 104 as well as rotor position sensors, gyroscopic sensors, accelerometers, and the like. As mentioned herein, it is contemplated that deploying the sensors 136 as thermo and/or mechanical sensors enables intelligently controlling operating temperatures of the electric motor and thus facilitates optimizing the cooling efficiency of the electric motor.

As disclosed in connection with FIG. 1, the system 100 may be powered by a small electric current induced in a winding 140 that is embedded or coupled with the rotor 104 and electrically connected to the telemetry controller 128 by way of wires 144. Preferably, the winding 140 is situated at a location of the rotor 104 wherein a magnetic flux passing through the winding 140 varies during operation of the electric motor. For example, in some embodiments, the winding 140 may be embedded in an outer-most region of at least one of the magnets 116, as shown in FIG. 1. In general, however, the winding 140 may be embedded or coupled with any suitable portion of the ferrous material 108 that does not adversely affect operation of the electric motor, without limitation.

As shown in FIG. 2, the telemetry controller 128 has wireless connectivity to the telemetry receiver 164. Generally, the telemetry controller 128 may include at least one processor 172 and a memory 176 and be configured to transmit wireless signals while rotating with the rotor 104 during operation of the electric motor. The telemetry receiver 164 may be disposed in a stationary configuration nearby the electric motor such that transmitted wireless signals, such as magnet temperature data, may be received from the telemetry controller 128 during operation of the electric motor. For example, in some embodiments, wherein the electric motor is implemented in an electric vehicle or a hybrid electric vehicle, the telemetry receiver 164 may be mounted to any stationary portion of the vehicle drivetrain wherein wireless connectivity may be established with the telemetry controller 128. It is contemplated that, in some embodiments, the telemetry receiver 164 may comprise any of a computer, a tablet, a mobile phone, a personal digital assistant (PDA), a personal communicator, or other similar device. It is further contemplated that the wireless connection between the telemetry controller 128 and the telemetry receiver 164 may comprise any wireless protocol suitable for transferring data, including any of Bluetooth, WiFi, NFC, and the like, without limitation.

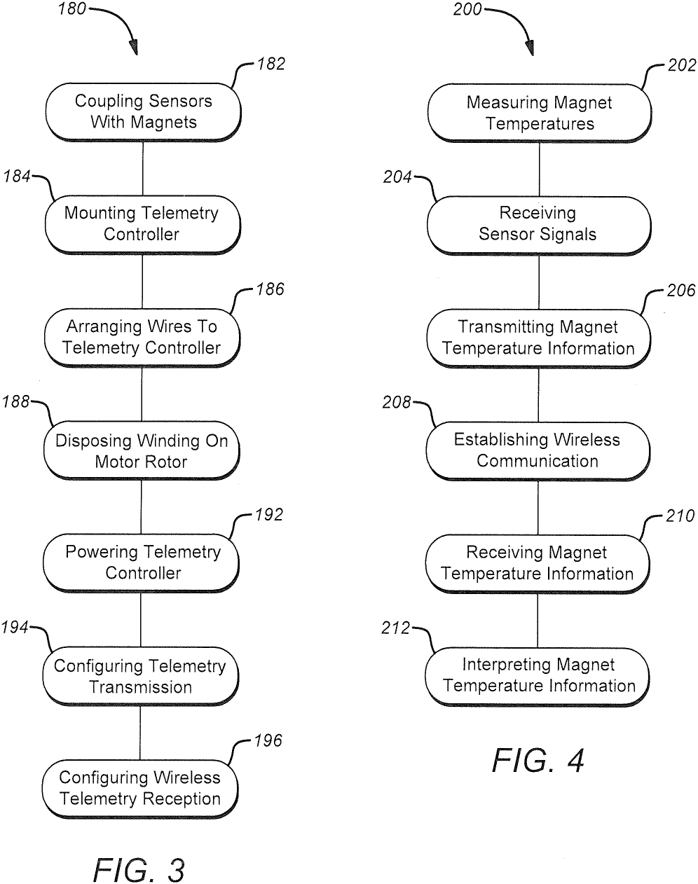

Turning, now, to FIG. 3, a flow chart illustrates an exemplary embodiment of a method 180 for an electric motor rotor telemetry system, such as the above discussed telemetry systems 100, 160, to monitor magnet temperatures within an operating electric motor in accordance with the present disclosure. The method 180 begins at a step 182 wherein one or more sensors 136 may be coupled with magnets 116 comprising a rotor 104 of the electric motor. In some embodiments, however, any one or more of the sensors 136 may be configured in the form of thermo sensors and disposed within the electric motor to measure any of bearing temperatures, ambient temperatures within the motor, rotor airgap temperatures, winding temperatures, cooling air temperatures, inlet air temperatures, outlet air temperatures, and the like. Further, in some embodiments, any one or more of the sensors 136 may be configured to detect winding hot spots, such as, for example, hot spots that may arise within stator windings of the electric motor. Moreover, any one or more of the sensors 136 may be implemented as mechanical sensors that are configured to detect machine vibrations that may arise during rotation of the rotor 104, as well as rotor position sensors, gyroscopic sensors, accelerometers, and the like.

Once the sensors 136 are desirably disposed within the electric motor, the method 180 advances to a step 184 comprising mounting a telemetry controller 128 to the rotor 104 of the electric motor. The telemetry controller 128 may include at least one processor 172 and a memory 176 and be configured to transmit wireless signals while rotating with the rotor 104 during operation of the electric motor. As such, the telemetry controller 128 may be mounted or embedded near a motor shaft 112 comprising the electric motor. It is contemplated that locating the telemetry controller 128 near the motor shaft 112 advantageously minimizes any impact the mass of the telemetry controller 128 may have on the rotational inertia of the rotor 104.

At a step 186, wires 168 may be arranged to place the telemetry controller 128 into electrical communication with the sensors 136 that are coupled with the magnets 116 and/or other components within the electric motor, as described herein. As will be appreciated, in some embodiments, the wires 168 are configured to convey temperature-related signals from the sensors 136 to the telemetry controller 128. Further, in some embodiments, the wires 168 may be arranged to form a parallel circuit wherein each of the wires 168 connects one sensor 136 to the telemetry controller 128 independently of the other sensors 136. However, in some embodiments, the sensors 136 may be connected in series to form a series circuit that connects the sensors 136 to the telemetry controller 128, as shown in FIG. 1.

Next, at a step 188, an inductive winding 140 may be embedded or coupled with at least one of the magnets 116 and electrically connected to the telemetry controller 128 by way of wires 144. The winding 140 may comprise a coil of wire that is configured to pass an electric current induced by varying magnetic flux to the telemetry controller 128 by way of the wires 144 during operation of the electric motor. The electric current induced may be a relatively small current that is suitable for powering the telemetry controller 128 and the sensors 136 without adversely affecting operation of the electric motor. In general, the winding 140 may be coupled with any portion of the rotor 140 that causes a varying magnetic flux to pass through the winding 140 during operation of the electric motor. As such, in some embodiments, the winding 140 may be embedded or coupled with any suitable portion of the ferrous material 108 comprising the rotor 104, without limitation. Further, in some embodiments, the winding 140 may comprise two or more windings having different shapes and sizes, without limitation. For example, in some embodiments, the winding 140 may be implemented as two or more small, circular windings that are adhered to exterior portions of the ferrous material 108 between adjacent magnets 116.

Once the inductive winding 140 is suitably configured in step 188, the telemetry controller 128 may be powered, in step 192, by way of a small electric current induced by passing a varying magnetic flux through the winding 140. As will be appreciated, the varying magnetic flux arises due to normal operation of the electric motor. It is contemplated, therefore, that the electric current for powering the telemetry controller 128 may be induced by scavenging a portion of the magnetic flux that is small enough to have no adverse effect on the operation of the electric motor. Thus, in some embodiments, the telemetry controller 128 may be powered by way of one or more windings 140 that are disposed in an outer-most region of at least one of the magnets 116, as shown in FIG. 1. In some embodiments, the telemetry controller 128 may be powered by way of one or more windings 140 that are coupled with any suitable portion of the ferrous material 108 comprising the rotor 104, without limitation.

As shown in FIG. 3, step 194 includes configuring the telemetry controller 128 to transmit sensor-related information by way of wireless signals while rotating with the rotor 104 during operation of the electric motor. As mentioned hereinabove, the sensor-related information may pertain to any one or more properties that are being detected by way of the sensors 136, such as, by way of non-limiting example, bearing temperatures, ambient temperatures within the motor, rotor airgap temperatures, winding temperatures, cooling air temperatures, inlet air temperatures, outlet air temperatures, winding hot spots, stator winding hot spots, as well as machine vibrations that may arise during rotation of the rotor 104. In some embodiments, configuring the telemetry controller 128 may include configuring the processor 172 and the memory 176 to store at least a portion of the sensor-related information so as to avoid losing data when the motor stops operating.

With continuing reference to FIG. 3, the method 180 concludes with a step 196 that includes configuring a telemetry receiver 164 for wirelessly receiving the sensor-related information from the telemetry controller 128. In general, the telemetry controller 128 has wireless connectivity to the telemetry receiver 164. The telemetry receiver 164 may be disposed in a stationary configuration nearby the electric motor such that transmitted wireless signals, such as magnet temperature data, for example, may be received from the telemetry controller 128 during operation of the electric motor. As mentioned above, in some embodiments, wherein the electric motor is implemented in an electric vehicle or a hybrid electric vehicle, the telemetry receiver 164 may be mounted to any stationary portion of the vehicle drivetrain wherein wireless connectivity may be established with the telemetry controller 128. It is contemplated that, in some embodiments, the telemetry receiver 164 may comprise any of a computer, a tablet, a mobile phone, a personal digital assistant (PDA), a personal communicator, or other similar device. It is further contemplated that the wireless connection between the telemetry controller 128 and the telemetry receiver 164 may comprise any wireless protocol suitable for transferring data, including any of Bluetooth, WiFi, NFC, and the like, without limitation.

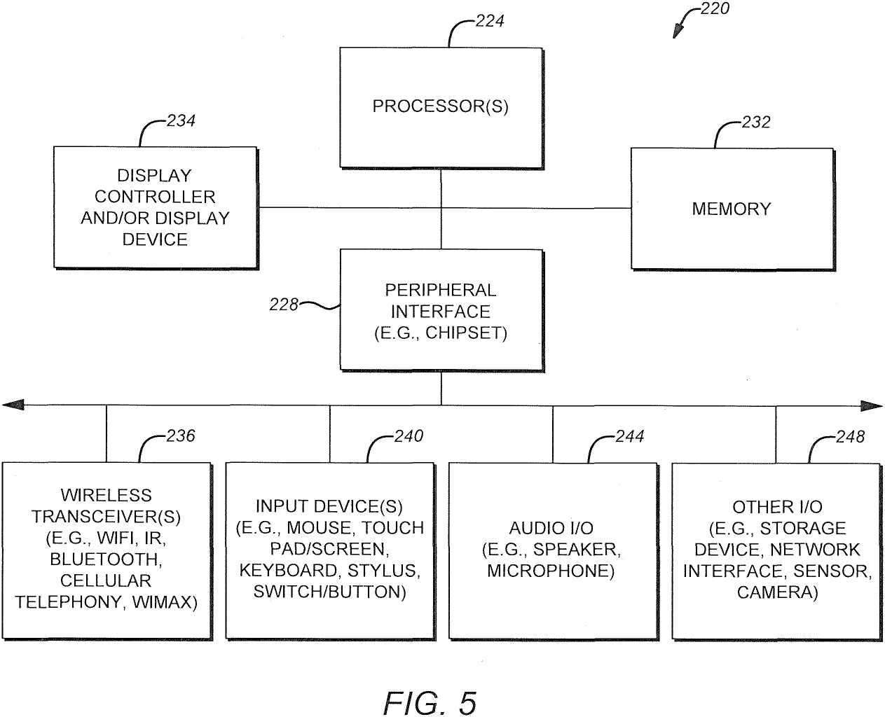

FIG. 4 is a flow chart illustrating an exemplary embodiment of a method 200 for monitoring magnet temperatures within an operating electric motor, according to the present disclosure. The method 200 begins at a step 202 comprising measuring magnet 116 temperatures. In some embodiments, the magnet 116 temperatures may be detected by way of sensors 136 coupled with the magnets 116 comprising a rotor 104 within the electric motor. It is contemplated that, in some embodiments, any one or more of the sensors 136 may be implemented in the form of thermo sensors that are embedded or attached to the magnets 116 for detecting the temperatures of the magnets 116.

Step 204 includes receiving signals from the sensors 136 to the telemetry controller 128. Wires 168 may be arranged on the rotor 104 to place the telemetry controller 128 into electrical communication with the sensors 136 that are coupled with the magnets 116 and/or other components within the electric motor, as described herein. In some embodiments, the wires 168 are configured to convey temperature-related signals from the sensors 136 to the telemetry controller 128. Further, the telemetry controller 128 may include a processor 172 and a memory 176 that are configured to store at least a portion of the sensor-related information so as to avoid losing data when the motor stops operating.

Step 206 includes transmitting magnet temperature-related information to a telemetry receiver 164. The telemetry controller 128 may be configured to transmit wireless signals while rotating with the rotor 104 during operation of the electric motor. Thus, while the electric motor is operating, a wireless communication may be established between the telemetry controller 128 and the telemetry receiver 164, in step 208, and magnet temperature-related information may be wirelessly transmitted to the telemetry receiver 164. In step 210, the telemetry receiver 164 receives the wirelessly transmitted magnet temperature-related information. It is contemplated that the wireless connection between the telemetry controller 128 and the telemetry receiver 164 may comprise any wireless protocol suitable for transferring data, including any of Bluetooth, WiFi, NFC, and the like, without limitation.

As shown in FIG. 4, the method 200 finishes with a step 212 that includes interpreting the magnet temperature-related information. To this end, the telemetry receiver 164 may, in some embodiments, comprise any of a computer, a tablet, a mobile phone, a personal digital assistant (PDA), a personal communicator, or other similar device that is capable of executing stored instructions for the purpose of interpreting the magnet temperature-related information. Further, in some embodiments, the telemetry receiver 164 may be configured to present the interpreted information to an end-user by way of, for example, a graphical user interface. In other embodiments, however, the telemetry receiver 164 may be configured to forward the interpreted information to a separate computer, or other suitable device. For example, in some embodiments, wherein the electric motor is implemented in an electric vehicle or a hybrid electric vehicle, the telemetry receiver 164 may be configured to forward magnet temperature-related information, or an interpretation thereof, to an engine control unit (ECU) that is configured to manage the operation of the vehicle. In such embodiments, the ECU may utilize magnet temperature-related information received from the telemetry receiver 164 to operate the electric motor, and thus the entire vehicle, at the greatest possible efficiencies in real-time.

Moreover, it should be borne in mind that the method 200, shown in FIG. 4, is not strictly limited to magnet temperature-related information. Thus, the method 200 may be used to measure and interpret sensor-related information pertaining to any one or more properties that are being detected by way of the sensors 136, such as, by way of non-limiting example, bearing temperatures, ambient temperatures within the motor, rotor airgap temperatures, winding temperatures, cooling air temperatures, inlet air temperatures, outlet air temperatures, winding hot spots, stator winding hot spots, as well as machine vibrations that may arise during rotation of the rotor 104, without limitation and without deviating beyond the scope of the present disclosure.

Turning, now, to FIG. 5, a block diagram illustrates an exemplary data processing system 220 that may be used in conjunction with the electric motor rotor telemetry system 160 to perform any of the processes or methods described herein. System 220 may represent circuitry within the telemetry receiver 164 of the electric motor rotor telemetry system 160, a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 5, system 220 includes a processor 224 and a peripheral interface 228, also referred to herein as a chipset, to couple various components to the processor 224, including a memory 232 and devices 236-248 via a bus or an interconnect. Processor 224 may represent a single processor or multiple processors with a single processor core or multiple processor cores included therein. Processor 224 may represent one or more general-purpose processors such as a microprocessor, a central processing unit (CPU), or the like. More particularly, processor 224 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 224 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 224 is configured to execute instructions for performing the operations and steps discussed herein.

Peripheral interface 228 may include a memory control hub (MCH) and an input output control hub (ICH). Peripheral interface 228 may include a memory controller (not shown) that communicates with a memory 232. The peripheral interface 228 may also include a graphics interface that communicates with graphics subsystem 234, which may include a display controller and/or a display device. The peripheral interface 228 may communicate with the graphics device 234 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 224. In such a configuration, the peripheral interface 228 operates as an interface chip performing some functions of the MCH and ICH. Furthermore, a graphics accelerator may be integrated within the MCH or the processor 224.

Memory 232 may include one or more volatile storage (or memory) devices, such as random access memory (RAM), dynamic RAM (DRAM), synchronous DRAM (SDRAM), static RAM (SRAM), or other types of storage devices. Memory 232 may store information including sequences of instructions that are executed by the processor 224, or any other device. For example, executable code and/or data of a variety of operating systems, device drivers, firmware (e.g., input output basic system or BIOS), and/or applications can be loaded in memory 232 and executed by the processor 224. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 228 may provide an interface to IO devices, such as the devices 236-248, including wireless transceiver(s) 236, input device(s) 240, audio IO device(s) 244, and other IO devices 248. Wireless transceiver 236 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 240 may include a mouse, a touch pad, a touch sensitive screen (which may be integrated with display device 234), a pointer device such as a stylus, and/or a keyboard (e.g., physical keyboard or a virtual keyboard displayed as part of a touch sensitive screen). For example, the input device 240 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 244 may include a speaker and/or a microphone to facilitate voice-enabled functions, such as voice recognition, voice replication, digital recording, and/or telephony functions. Other optional devices 248 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 248 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 5 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system’s memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals - such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

List of Reference Numbers

| | |
|---|---|
| 100 | electric motor rotor telemetry system |
| 104 | rotor |
| 108 | ferrous material |
| 112 | motor shaft |
| 116 | magnets |
| 120 | recesses |
| 124 | periphery |
| 128 | telemetry controller |
| 132 | wires |
| 136 | sensors |
| 140 | an inductive winding |
| 144 | wires |
| 160 | electric motor rotor telemetry system |
| 164 | telemetry receiver |
| 168 | wires |
| 172 | processor |
| 176 | memory |
| 180 | method |
| 182 | step |
| 184 | step |
| 188 | step |
| 192 | step |
| 194 | step |
| 196 | step |
| 200 | method |
| 204 | step |
| 206 | step |
| 208 | step |
| 210 | step |
| 212 | step |
| 220 | data processing system |
| 224 | processor |
| 228 | peripheral interface |
| 232 | memory |
| 234 | graphics device |
| 236 | wireless transceiver |
| 240 | input device(s) |
| 244 | audio IO device(s) |
| 248 | other IO devices |

What is claimed is:

1. An electric motor, comprising:
a rotor; and
a telemetry system coupled with the rotor.

2. The electric motor of claim 1, wherein the telemetry system includes a telemetry controller that is disposed on the rotor near a motor shaft comprising the electric motor.

3. The electric motor of claim 2, wherein the telemetry system includes a telemetry receiver that is configured to be disposed in a stationary disposition nearby the electric motor such that transmitted wireless signals may be received from the telemetry controller during operation of the electric motor.

4. The electric motor of claim 1, wherein the telemetry system comprises one or more sensors for measuring properties of the rotor.

5. The electric motor of claim 4, wherein any one or more of the one or more sensors are coupled with magnets comprising the rotor.

6. The electric motor of claim 4, wherein any one or more of the one or more sensors are coupled with suitable portions of ferrous material comprising the rotor.

7. The electric motor of claim 1, wherein the telemetry system includes a winding that is disposed on a portion of the rotor that causes a varying magnetic flux to pass through the winding during operation of the electric motor.

8. A telemetry system for being coupled with a rotor of an electric motor, comprising:
one or more sensors for measuring properties of the rotor;
a telemetry controller for receiving signals from the one or more sensors;
a winding for powering the telemetry controller; and
a telemetry receiver for wirelessly receiving measurement data from the telemetry controller.

9. The telemetry system of claim 8, wherein the telemetry controller includes at least one processor and is configured to transmit wireless signals while rotating with the rotor during operation of the electric motor.

10. The telemetry system of claim 8, wherein wires are arranged to place the telemetry controller into electrical communication with the one or more sensors.

11. The telemetry system of claim 8, wherein any one or more of the one or more sensors are configured to measure temperature.

12. The telemetry system of claim 8, wherein the winding is configured to pass an electric current induced by a varying magnetic flux to the telemetry controller.

13. The telemetry system of claim 12, wherein the winding is disposed on at least one magnet comprising the rotor.

14. The telemetry system of claim 12, wherein the winding is disposed on a suitable portion of ferrous material comprising the rotor.

15. The telemetry system of claim 8, wherein the winding comprises two or more smaller windings disposed at different locations of the rotor.

16. The telemetry system of claim 15, wherein the two or more smaller windings having different shapes and sizes.

17. The telemetry system of claim 8, wherein the telemetry receiver is configured for wirelessly receiving temperature-related information pertaining to magnets comprising the rotor.

18. The telemetry system of claim 8, wherein the telemetry receiver comprises any of a computer, a tablet, a mobile phone, a personal digital assistant, a personal communicator, or other similar device.

19. A method for a telemetry system for monitoring magnet temperatures within an operating electric motor, comprising:
coupling one or more sensors with magnets comprising a rotor of the electric motor for measuring the magnet temperatures;
mounting a telemetry controller near a motor shaft comprising the rotor for receiving signals from the one or more sensors;
arranging wires to place the telemetry controller into electrical communication with the one or more sensors;
disposing a winding on a portion of the rotor that induces an electric current in the winding;
powering the telemetry controller by way of the electric current;
configuring the telemetry controller to transmit temperature-related information pertaining to the magnets;
configuring a telemetry receiver for wirelessly receiving the temperature-related information;
establishing a wireless communication between the telemetry controller and a telemetry receiver;
receiving the magnet temperature information to the telemetry receiver; and
interpreting the magnet temperature information.

20. The method of claim 19, wherein disposing the winding includes coupling the winding with a portion of the rotor that causes a varying magnetic flux to pass through the winding during operation of the electric motor.
